(19) United States
(12) Patent Application Publication
(10) Pub. No.: US 2013/0281184 A1
(43) Pub. Date: Oct. 24, 2013

(54) Dice Game

(71) Applicant: Karsten Bording, Fredericia (DK)

(72) Inventor: Karsten Bording, Fredericia (DK)

(21) Appl. No.: 13/865,603

(22) Filed: Apr. 18, 2013

Related U.S. Application Data
(60) Provisional application No. 61/625,915, filed on Apr. 18, 2012.

(51) Int. Cl. G07F 17/32

(52) U.S. Cl. CPC G07F 17/3286
USPC 463/22

(57) ABSTRACT

An electronic version of a dice game for one or more players playable on a variety of mobile and stationary computer platforms such as a tablet, a smart phone, or a computer and a method of playing the same, is disclosed. The dice game provides significantly more possible outcomes and dilemmas for the user through the use of a plurality of columns wherein each of the plurality of columns has a different multiplication factor.

### CROSS-REFERENCE

This application claims priority from Provisional Patent Application Ser. No. 61/625,915 filed on Apr. 18, 2012.

### COPYRIGHT NOTICE

A portion of the disclosure of this provisional patent application contains material which is subject to copyright protection. The patent owner has no objection to facsimile reproduction by anyone of the patent document or the patent disclosure, as it appears in the Patent and Trademark Office patent file or records, but otherwise reserves all copyright rights whatsoever.

### FIELD OF THE INVENTION

This invention relates to a dice game, and more particularly to a dice game for one or more players that is played on a variety of smart phone, tablet, and computer platforms, and a method of playing the same.

### BACKGROUND

A wide variety of games have been played by millions of people for many years. Popular games such as Kalaha, backgammon, and chess have been played and enjoyed by people for generations. Additionally, many newer games such as Monopoly®, Scrabble®, Trivial Pursuit®, Mastermind®, and Yahtzee® have become popular in later years. A common theme for these types of games is that they can be played by multiple players, such as family members, and are relatively simple to learn and highly enjoyable to play. The games are also relatively easy and inexpensive to manufacture from basic materials, such as paper, wood, plastic, cardboard, and the like.

Ever since the introduction of computers, the interne, and more recently, smart phones and computer tablets, many traditional board and dice games have been converted, updated, and/or redesigned to accommodate these new platforms. Thanks to advances in the telecommunications network and the internet, users may now play these types of games on their computers, smart phones and tablet devices, and may participate in games with players from remote locations. An example of an updated traditional board game that has been converted to an electronic version is the game Scrabble®. For years, players enjoyed this game on the traditional cardboard game board platform. However, electronic versions, such as Wordfeud® and Words With Friends®, have enjoyed a much larger audience through smart phones and computer tablets.

Another well known game that has an electronic version is the dice game Yahtzee®. The purpose of this game is for one or more players to use a plurality of dice to create specific scoring combinations. A player may roll the dice up to three times per turn. There are fifteen different scoring combinations based on the best poker hand created by the five dice, and a game is typically comprised of fifteen rounds. The winner is the player with the highest point total after the final round. The traditional version of the game requires that the players roll real dice and record the results by hand. The electronic versions simplify the process with the computing device simulating the roll and recording the results electronically.

Consequently there is a need for newer updated versions of traditional games that are more convenient and easier to play. The present invention uses the traditional Yahtzee® game platform as a starting point with the addition of novel and non-obvious features and rules. The new game is designed specifically for use with smart phone, tablet, and computer platforms.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an electronic version of a dice game for one or more users playable on a variety of various smart phone, tablet, and computer platforms. The present invention preferably comprises a dice game for use on a mobile electronic device that allows one or more players to interact over the internet while playing the dice game based on five dice, and a method of playing the same. Additionally, the dice game automatically provides electronic calculations and record keeping.

The objective of the dice game is to provide an electronic version of a dice game for use with mobile computing platforms such as a smart phone, a PDA device, or a tablet computer that are compatible with operating software such as Android®, Microsoft Windows®, and iOS. The dice game creates significantly more possible outcomes and dilemmas for the user in addition to requiring some kind of comprehensive views and probability calculations. Furthermore, the dice game calculates results in a way that makes the game more clear to the user and thereby increases the ease of use.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of an electronic dice game in accordance with the disclosed architecture.

FIG. 2 illustrates a perspective view of the electronic dice game as seen on a computer based application in accordance with the disclosed architecture.

FIG. 3 illustrates a ranking page for the electronic dice game in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

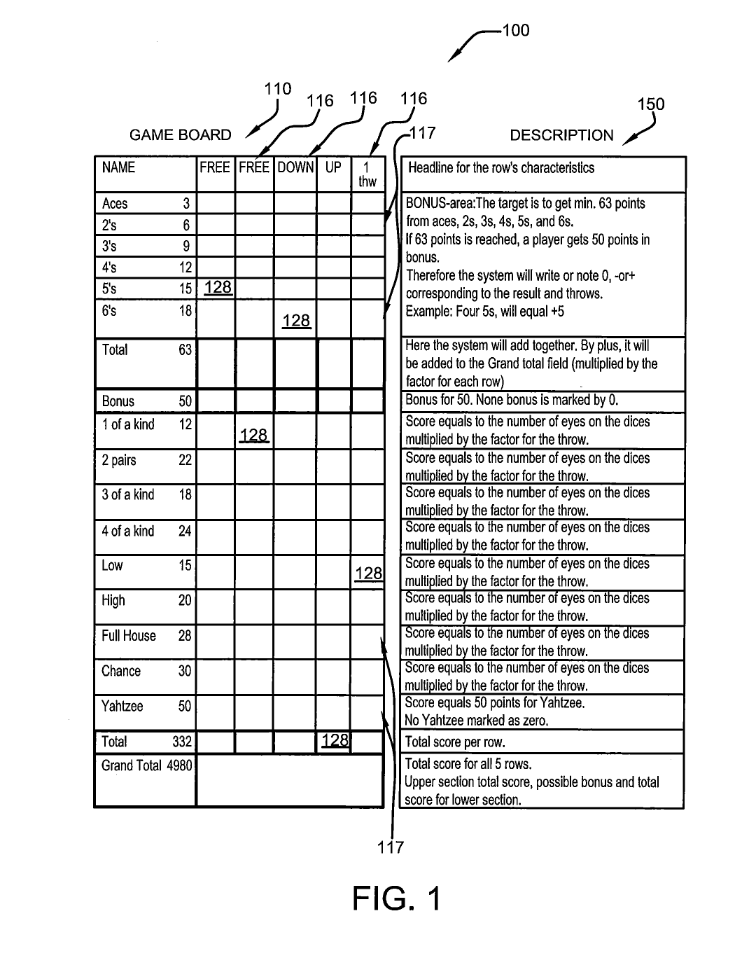

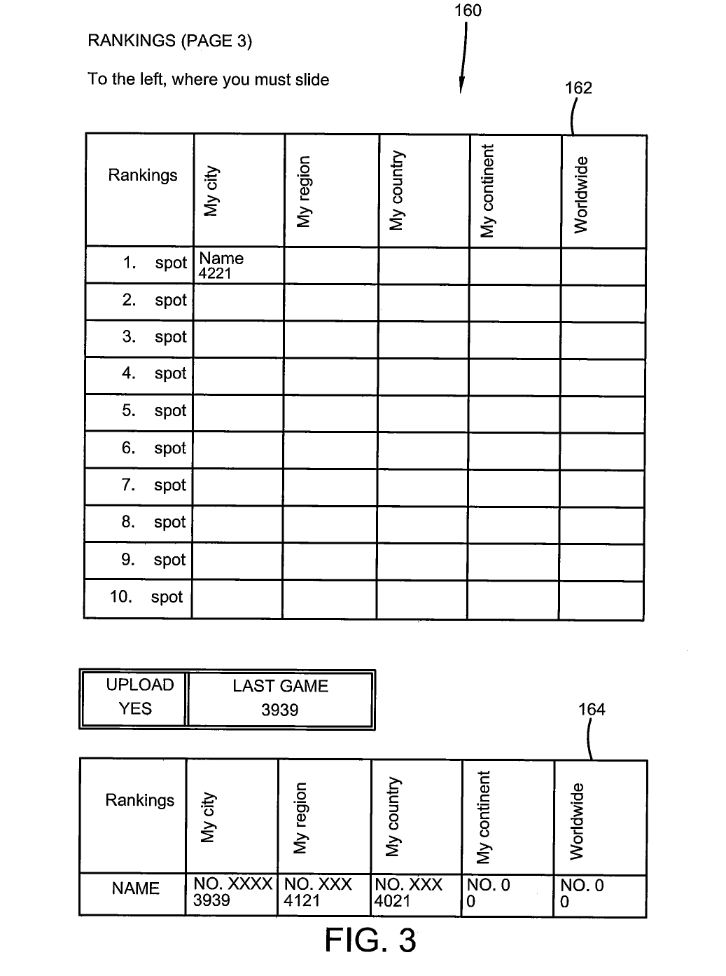

Referring initially to the drawings, FIGS. 1-3 illustrate an electronic dice game 100 comprising a game board description page 110, a first player game board page 112, a second player game board page 114, and a rankings page 160. The electronic dice game 100 is loosely based on the game Yahtzee® in that the object of the electronic dice game 100 is to score the most points by rolling electronic dice to make certain scoring combinations.

The first player game board page 112 and the second player game board page 114 each comprise a pseudo-random number generator. The pseudo-random number generator comprises five electronic dice 170. The five electronic dice 170 may each generate a number between one and six. Furthermore, the number from each of the five electronic dice 170 may be randomly generated up to three times per turn to try to make one possible scoring combination. The first and the second player game pages 112 and 114 each further comprise a plurality of columns 116, a plurality of rows 117, and a plurality of fields 128. Preferably, there are five columns, 20 rows, and 91 scoring fields (including score totaling fields).

A game may comprise at least 15 rounds during which each player chooses which row 117 and associated scoring combination is to be used in that round. Once a particular row 117 and associated scoring combination has been used in a game, it cannot be used again in that game. Each row 117 and associated scoring combination has varying point values, some of which are fixed values and others of which have the cumulative value of the five electronic dice 170. A “Yahtzee” is a five-of-a-kind and provides the game's highest point value of 50 (not counting multiple “Yahtzee's” in the same game) multiplied by a factor, as discussed infra.

The electronic dice game 100 of the present invention is typically for use with a mobile electronic device. Preferred mobile electronic devices comprise smart phones, computer tablets, laptop computers, and the like; however, this is not meant as a limitation, as any electronic device with access to the interne, any communication network, or a software input may be used without affecting the overall scope of the invention. To begin a new game, the player simply logs into the electronic dice game 100 on the particular mobile electronic device, and is assigned either the first player game board page 112 or the second player game board page 114, though it is also contemplated that additional player game board pages could also be included.

Unlike Yahtzee®, the electronic dice game 100 of the present invention further comprises a description chart 150 enumerating a list of instructions for how to play the electronic dice game 100. Additionally, each player plays a plurality of columns 116, rows 117 and a plurality of scoring fields 128 on the respective game board 110 simultaneously. As such there is no requirement about which of the plurality of columns 116 or the plurality of fields 128 must be used first so the player may move between each of the plurality of columns 116 depending on the needs of the player and the possibilities from the outcome of the roll.

As seen in the description chart 150, each of the plurality of columns 116 have rules for how the rolled dice combination may be used. A first column 118 and a second column 120 permit optional placement of dice combinations. A third column 122 requires placing the dice combinations in order starting with aces (i.e., 1's), then 2's, then 3's, and so on, ending with a “Yahtzee” at the bottom of the third column 122. A fourth column 124 requires placing the dice combinations in the opposite order as in the third column 122, from the bottom up. A fifth column 126 requires that the dice combination used be rolled in a single roll instead of up to three rolls. For example, if the player rolls two of a kind on a first roll and a three of a different kind on a second roll, the three of a different kind may be used in the fifth column 126 instead of using the full house in another column. Furthermore, each of the plurality of fields 128 in each of the plurality of columns 116 are multiplied by the following factors: the first column 118 (immediately to the right of the name column) is multiplied by one, the second column 120 is multiplied by two, the third column 122 is multiplied by three, the fourth column 124 is multiplied by four and the fifth column 126 is multiplied by five.

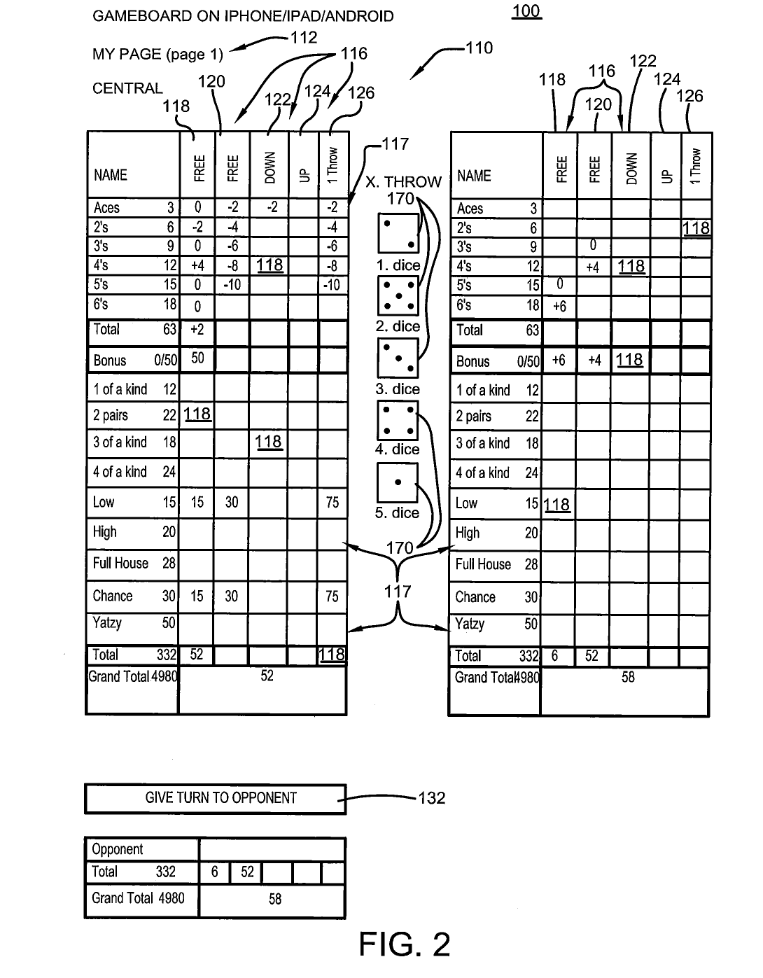

As illustrated in FIG. 2, both the first player game board page 112 and the second player game board page 114 are each set up with the plurality of columns 116 and the plurality of rows 117, which serve to form the plurality of scoring fields 128. After each turn, the respective player must select one of the plurality of scoring fields 128 where the result or score will be entered. As such, plurality of scoring fields 128 further comprise a plurality of colors to indicate available options for the player dependant on the outcome of the roll.

For example, after each roll all of the plurality of scoring fields 128 that are colored green indicate possible score results for the given roll and are selectable by the player. This makes the game easier to learn because it specifically identifies the available options for the player. All of the plurality of scoring fields 128 that are colored yellow indicate an unused field that does not match the outcome of the roll. In other words, the dice roll combination does not match the scoring field requirement for that turn. Therefore, if chosen no points will be obtained as it corresponds to erasing or deleting the field from later selection. All of the plurality of scoring fields 128 colored red indicate that the scoring field has previously been used from the results of a prior turn or that it was deleted, therefore that scoring field may no longer be selected. Once the player completes a turn, an indicator button 132 located on the first or the second player game board page 112, 114, respectively, is selected and the turn is transferred to the opponent. However, even after selecting the scoring field for the roll, the player may still change the scoring field or re-roll the dice until the indicator button 132 is selected.

The electronic dice game 100 further comprises a first counting method used in an upper bonus area, and a second counting method used in a lower area as described in the description chart 150. To obtain a bonus, the player must reach a total of 63 points or more for the applicable column. For example, by achieving three of a kind for aces (i.e., 1's), 2's, 3's, 4's, and 5's for a particular column, the point total is 63. The dice game 100 will automatically populate a score of zero in the corresponding field whenever a three of a kind is rolled. However, if a three of a kind is not rolled, the electronic dice game 100 will indicate a minus score in that field with the number corresponding to a number of eyes of the dice. For example, if two aces (ones) are rolled, the field will be populated with a negative 1 (−1) score. Alternatively, if more than three of a kind is rolled, the electronic dice game 100 will indicate a positive score in that scoring field where the number corresponds to a number of eyes of the dice. For example, if four fives are rolled, the scoring field will be populated with a positive (+5) score. The second counting method simply adds together the various scores from the various rolls, and includes the multiple factor for the column.

Each of the first and second player game board pages 112, 114, respectively, preferably further comprise a row 117 labeled “Chance”. A player may elect to input the sum of the rolled dice in the “Chance” scoring field 128 if that, in the player's opinion, is the best available alternative at the time.

The electronic dice game 100 also has at least two options for play. First, the player may duel against a single opponent through an invitation to play by either party. Results for each game may be uploaded onto one or more ranking pages 160 which may further comprise a leader board 162 and a player rankings chart 164. Additionally, the ranking page 160 may designate the leader board 162 and/or the player rankings chart by geographic area, such as a region in a particular city, a country, a continent, worldwide, or by another designatable grouping. A second option for play is on a practice field (not shown) or a solitaire version of the electronic dice game 100. As such, the player may play alone or against an imaginary opponent. However, it is not possible to upload results from the second option to the ranking page 160.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An electronic dice game for use with a mobile electronic device, the electronic dice game comprising:
a game board description page; and
at least one player game board page comprising a pseudo-random number generator, a plurality of columns, a plurality of rows, and a plurality of scoring fields; and
at least one rankings page.

2. The electronic dice game of claim 1, wherein the pseudo-random number generator generates a number between one and six for each of a plurality of dice.

3. The electronic dice game of claim 2, wherein the pseudo-random generator comprises five electronic dice.

4. The electronic dice game of claim 3, wherein a number from each of the five dice is independently generated.

5. The electronic dice game of claim 1, wherein the plurality of columns comprise five columns.

6. The electronic dice game of claim 5, wherein the plurality of rows comprise twenty rows.

7. The electronic dice game of claim 6, wherein the plurality of scoring fields comprise 91 scoring fields.

8. An electronic dice game for use with a mobile electronic device, the electronic dice game comprising:
a game board description page; and
a first and a second player game board page each comprising a pseudo-random number generator, a plurality of columns, a plurality of rows, and a plurality of scoring fields; and
at least one rankings page.

9. The electronic dice game of claim 8, wherein the pseudo-random generator comprises five electronic dice.

10. The electronic dice game of claim 9, wherein a number from each of the five dice is independently generated.

11. The electronic dice game of claim 10, wherein the number from each of the five dice is independently generated between one and three times during one turn.

12. The electronic dice game of claim 8, wherein a game comprises at least 15 turns for each of the first and the second player.

13. The electronic dice game of claim 8, wherein a final score of the game is uploaded to said at least one ranking page.

14. The electronic dice game of claim 8, wherein the plurality of columns comprise five columns, the plurality of rows comprise twenty rows, and the plurality of scoring fields comprise 91 scoring fields.

15. A software implemented method for playing an electronic dice game, the method comprising:
providing a mobile electronic device for implementing the electronic dice game;
logging in a first and a second player;
assigning a player page to the first and the second player;
randomly generating five numbers between one and six for a first player;
assigning the five numbers to a select one of a plurality of columns and a plurality of rows on the first player page;
randomly generating five numbers between one and six for a second player;
assigning the five numbers to a select one of a plurality of columns and a plurality of rows on the second player page;
repeating randomly generating five numbers between one and six alternating between the first player and the second player;
multiplying each completed row by a predetermined factor;
uploading a result of a completed game to a rankings page.

16. The method of claim 15, further comprising randomly generating five numbers on a first dice roll.

17. The method of claim 16, further comprising randomly generating up to five new numbers on a second dice roll.

18. The method of claim 17, further comprising randomly generating up to five new numbers on a third dice roll.

19. The method of claim 18, further comprising alternating turns between the first player and the second player at least fifteen times.

20. The method of claim 19, further comprising selecting a winner from a highest score of a completed game.
